(19) United States
(12) Patent Application Publication
(10) Pub. No.: US 2026/0086278 A1
(43) Pub. Date: Mar. 26, 2026

(54) PROJECTION DEVICE

(71) Applicant: GUANGZHOU LUXVISIONS INNOVATION TECHNOLOGY LIMITED, Guangzhou City (CN)

(72) Inventor: Chih-Hao Lin, Guangzhou City (CN)

(73) Assignee: GUANGZHOU LUXVISIONS INNOVATION TECHNOLOGY LIMITED, Guangzhou City (CN)

(21) Appl. No.: 19/195,186

(22) Filed: Apr. 30, 2025

(30) Foreign Application Priority Data
Sep. 23, 2024 (CN) 202411324531.6

(51) Int. Cl. F21V 8/00; G02B 27/01; G02B 27/18

(52) U.S. Cl. CPC G02B 6/0035; G02B 6/0055; G02B 27/0101; G02B 27/18

(57) ABSTRACT

A projection device is provided, including an imaging module and a light guide plate. The imaging module generates a parallel light beam. The light guide plate includes a light incident surface, a light emergence surface, and a plurality of transflective interfaces. The light incident surface is coupled to the imaging module, and the light incident surface forms a first oblique angle with the light emergence surface. The plurality of transflective interfaces are provided inside the light guide plate. The plurality of transflective interfaces form a second oblique angle with the light emergence surface, and are arranged in sequence along an optical axis parallel to the light emergence surface.

### CROSS-REFERENCE TO RELATED APPLICATION

This non-provisional application claims priority under 35 U.S.C. § 119 (a) to patent application No. 202411324531.6 filed in China on Sep. 23, 2024, the entire contents of which are hereby incorporated by reference.

### BACKGROUND

### Technical Field

This application relates to optical devices, and in particular, to an optical projection device.

### Related Art

The conventional augmented reality head-up display (AR HUD) has a significant problem: a short distance of a virtual image generated by an imaging component differs greatly from a distance of an object in an external environment observed by a driver. When the driver switches the focus of line of sight, eyes need to perform frequent adjustment between the close-range virtual image and a long-range external object, which may lead to visual fatigue. Especially in the case of long-term driving, such frequent focal length adjustment may cause discomfort to eyes of the driver, even cause the position of focused attention of the driver to deviate from the external object, and affect driving safety. Therefore, how to effectively reduce visual disparity between a virtual image distance and an external environment object has become a major challenge in the development of AR HUD technology.

### SUMMARY

In view of the above, the applicant proposes a projection device, including an imaging module and a light guide plate. The imaging module generates a parallel light beam. The light guide plate includes a light incident surface, a light emergence surface, and a plurality of transflective interfaces. The light incident surface is coupled to the imaging module, and the light incident surface forms a first oblique angle with the light emergence surface. The plurality of transflective interfaces are provided inside the light guide plate. The plurality of transflective interfaces form a second oblique angle with the light emergence surface, and are arranged in sequence along an optical axis parallel to the light emergence surface.

In an embodiment of the projection device of this application, the projection device includes a transflective plate. The transflective plate is arranged above the light emergence surface of the light guide plate, and the transflective plate forms a third oblique angle with the light emergence surface.

In an embodiment of the projection device of this application, the first oblique angle is less than 90 degrees and greater than a critical angle of total reflection of the parallel light beam on the light guide plate.

In an embodiment of the projection device of this application, the light guide plate is composed of a plurality of light guide media. Each of the plurality of transflective interfaces is a coated surface between the light guide media.

In an embodiment of the projection device of this application, the light guide plate includes a cavity and a reflective surface. The light emergence surface of the light guide plate is a transflective surface. The cavity is located between the transflective surface and the reflective surface. The plurality of transflective interfaces are a plurality of transflective lenses in the cavity.

In an embodiment of the projection device of this application, a spacing between the plurality of transflective interfaces along the optical axis is equal.

In an embodiment of the projection device of this application, the plurality of transflective interfaces include N transflective interfaces, and a reflectivity of each of the transflective interfaces is expressed as:

$${R}_{i} = \frac{1}{N} \times \frac{1}{{\prod }_{j = 1}^{i - 1} 1 - {R}_{j}}$$

where R is the reflectivity, and i is a rank of one of the transflective interfaces, with the ranks of the transflective interfaces ordered in ascending order of distances to the light incident surface.

In an embodiment of the projection device of this application, the imaging module includes a display screen and a lens assembly. The display screen generates a divergent light beam. The lens assembly converts the divergent light beam into the parallel light beam. The lens assembly includes a first biconvex lens, a second biconvex lens, a first biconcave lens, a second biconcave lens, a convex-concave lens, and a third biconvex lens in sequence.

In an embodiment of the projection device of this application, the imaging module includes a prism, the prism is arranged between the display screen and the lens assembly, and the display screen is coupled to a light incident surface of the prism.

In an embodiment of the projection device of this application, the imaging module includes a plurality of display screens, a light combining component, and a lens assembly. Each of the display screens generates a divergent monochromatic light beam. The light combining component is arranged between the plurality of display screens and the lens assembly. Each of the display screens is coupled to a different light incident surface of the light combining component. The light combining component mixes a plurality of divergent monochromatic light beams to generate a divergent combined light beam. The lens assembly converts the divergent combined light beam into the parallel light beam.

### BRIEF DESCRIPTION OF THE DRAWINGS

FIG. 1 is a schematic diagram of an operating status of an existing projection apparatus.

FIG. 2 is a schematic diagram of a projection device according to some embodiments of this application.

FIG. 3A is a schematic diagram of a light guide plate according to some embodiments of this application.

FIG. 3B is a schematic diagram of a light guide plate according to some other embodiments of this application.

FIG. 4 is a schematic diagram of an imaging module according to a first embodiment of this application.

FIG. 5A is a diagram of a modulation transfer function (MTF) of an imaging module according to some embodiments of this application.

FIG. 5B is a diagram of field curvature of an imaging module according to some embodiments of this application.

FIG. 5C is a distortion diagram of an imaging module according to some embodiments of this application.

FIG. 6 is a schematic diagram of an imaging module according to a second embodiment of this application.

FIG. 7 is a schematic diagram of an imaging module according to a third embodiment of this application.

### DETAILED DESCRIPTION

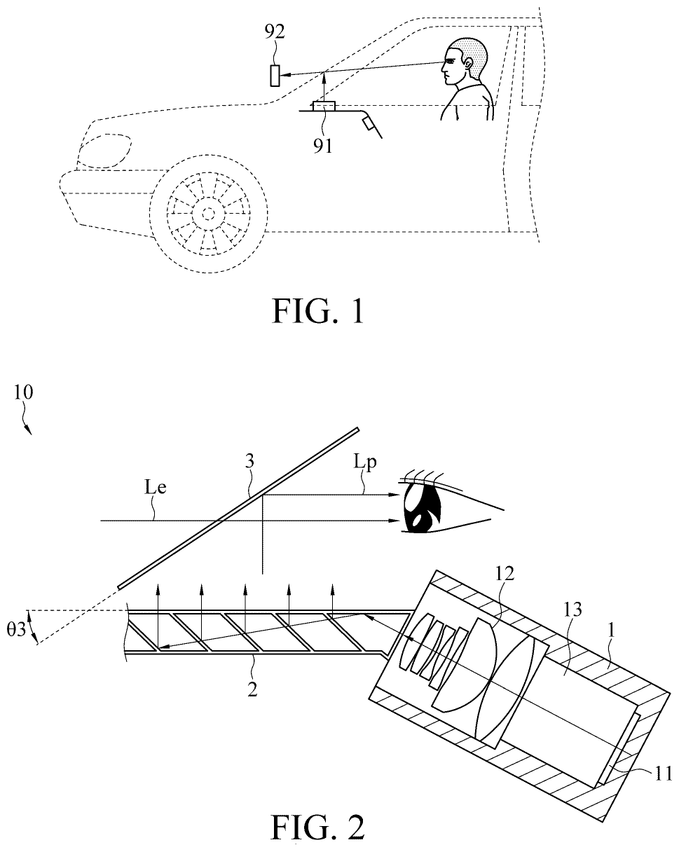

FIG. 1 is a schematic diagram of an operating status of an existing projection apparatus. Refer to FIG. 1. A projection apparatus 91 is arranged in front of a windshield of a vehicle, and a light beam projected by the projection device is reflected by the windshield to a driver. The reflected light beam of the windshield forms a virtual image 92 behind the windshield, and an image distance of the virtual image is equivalent to a distance between the projection apparatus 91 and the windshield. When observing the virtual image 92, the driver needs to limit an observation angle to a specific range, so as to receive the reflected light beam from the windshield.

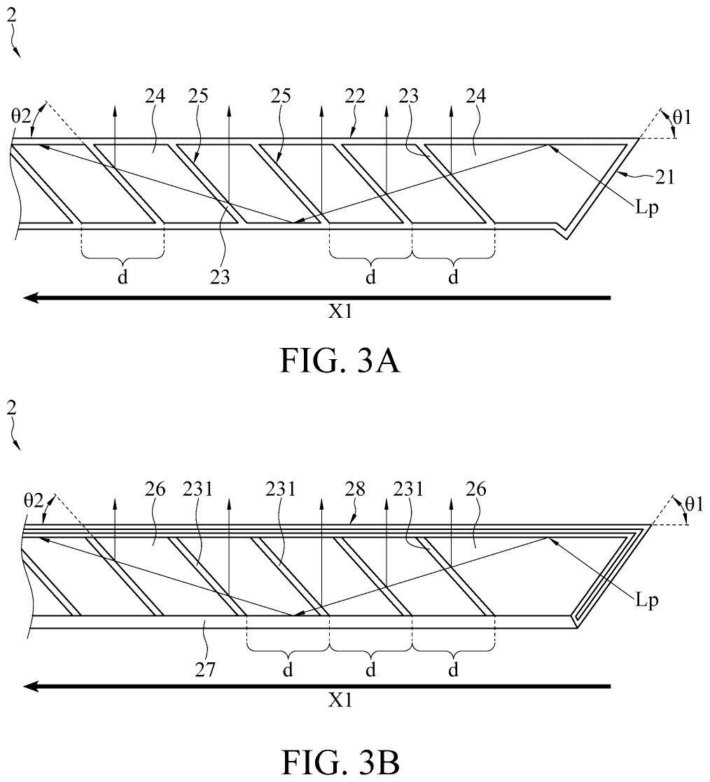

FIG. 2 is a schematic diagram of a projection device according to some embodiments of this application. FIG. 3A is a schematic diagram of a light guide plate according to some embodiments of this application. Refer to FIG. 2 and FIG. 3A together. The projection device 10 includes an imaging module 1 and a light guide plate 2. A light incident surface 21 of the light guide plate 2 is coupled to the imaging module 1. In this embodiment, the imaging module 1 is configured to generate a parallel light beam Lp. The parallel light beam Lp enters the light guide plate 2 through the light incident surface 21, and partially passes through each transflective interface 23 and is partially reflected inside the light guide plate 2. Finally, all reflected parallel light beams Lp are projected onto an observer. The projection device 10 may be placed in front of partially transparent glass, for example, but not limited to, a windshield of a vehicle. In this embodiment, as shown in FIG. 2, the projection device 10 includes the imaging module 1, the light guide plate 2, and a transflective plate 3. The transflective plate 3 is arranged above a light emergence surface 22 of the light guide plate 2, and the transflective plate 3 forms a third oblique angle θ3 with the light emergence surface 22 of the light guide plate 2. In this way, the parallel light beam Lp from the light emergence surface 22 of the light guide plate 2 is partially reflected by the transflective plate 3 to the observer. In addition, the observer may also receive an external light beam Le through the transflective plate 3, and therefore may simultaneously observe an image formed by the parallel light beam Lp and the external light beam Le.

As shown in FIG. 3A, the light guide plate 2 includes the light incident surface 21, the light emergence surface 22, and a plurality of transflective interfaces 23. In this embodiment, the light incident surface 21 is arranged on a plate side of the light guide plate 2, and the light incident surface 21 forms a first oblique angle θ1 with the light emergence surface 22. In this way, when the parallel light beam Lp passes through the light incident surface 21 orthogonally, an incident angle and a reflection angle of the parallel light beam Lp on the light emergence surface 22 are also the first oblique angle θ1. A larger first oblique angle θ1 indicates more transflective interfaces 23 through which the parallel light beam Lp can pass, thereby widening the observation range of the image. A smaller first oblique angle θ1 indicates a higher proportion of light of the parallel light beam Lp reflected by each of the transflective interfaces 23, so that the visibility of the image is higher. The plurality of transflective interfaces 23 are provided inside the light guide plate 2 and arranged in sequence along an optical axis X1. A direction of the optical axis X1 is equivalent to a projection component of a traveling direction of the parallel light beam Lp on the light emergence surface 22. The light guide plate 2 of this embodiment includes five transflective interfaces 23, which are arranged in sequence along a left-right direction in FIG. 3A.

Each of the transflective interfaces 23 forms a second oblique angle θ2 with the light emergence surface 22. The parallel light beam Lp is partially reflected and partially passes through the transflective interface 23. A larger second oblique angle θ2 indicates more transflective interfaces 23 through which the parallel light beam Lp can pass, so that a range of observation of the image is wider. A smaller second oblique angle θ2 indicates a higher proportion of light of the parallel light beam Lp reflected by each of the transflective interfaces 23, so that the visibility of the image is higher. In this embodiment, an incident angle of the parallel light beam Lp on a first transflective interface 23 is equivalent to the first oblique angle θ1 minus the second oblique angle θ2. In some embodiments, the first oblique angle θ1 is not equal to the second oblique angle θ2, to prevent the parallel light beam Lp from orthogonally passing through one or more transflective interfaces 23 without being reflected. In some embodiments, twice a sum of the second oblique angle θ2 and the third oblique angle θ3 minus the first oblique angle θ1 is 90 degrees (that is, 2*(θ2+θ3)−θ1=90°), so that a reflected light beam of the transflective plate 3 is parallel to the light guide plate 2, thereby enabling the observer to maximally observe a projected image at an eye-level angle.

In some embodiments, the light guide plate 2 is composed of a plurality of light guide media 24, and each of the plurality of transflective interfaces 23 is a coated surface 25 between the light guide media 24. In this embodiment, the light guide plate 2 includes six light guide media 24 and five coated surfaces 25 between the light guide media 24. A material of each of the light guide media 24 may be, but is not limited to, polymethyl methacrylate (PMMA), polycarbonate (PC), polystyrene (PS), quartz glass (SiO₂), multi-mode or single-mode optical fiber, fluoride glass, polymer optical fiber (POF), sapphire crystal (Al₂O₃), or lithium niobate (LiNbO₃). In some embodiments, the first oblique angle θ1 is less than 90 degrees and greater than a critical angle θc of total reflection of the parallel light beam Lp on the light guide plate 2. For the critical angle θc of total reflection of the parallel light beam Lp, a refractive index n1 of the light guide medium 24 and a refractive index n2 of an external medium should be taken into consideration (assuming that the external medium is air, the refractive index n2 is 1), which may be expressed as the following Equation I:

$$θ c = {sin}^{- 1} ( \frac{{n}_{2}}{{n}_{1}} ) . \qquad ( Equation I )$$

In this way, when the first oblique angle θ1 is greater than the critical angle of total reflection of the parallel light beam Lp on the light guide plate 2, the parallel light beam Lp may maximally travel along the optical axis X1 inside the light guide plate 2 without being refracted during the reflection of the light emergence surface 22 to cause energy dissipation, thereby passing through a largest quantity of transflective interfaces 23 to form the widest visible range of the image. In some embodiments, the light emergence surface 22 may also be coated to form a coated surface 25 with the refractive index n2. In this embodiment, for the critical angle of total reflection of the parallel light beam Lp, the refractive indexes of the light guide media 24 and the coated light emergence surface 22 are taken into consideration simultaneously.

In some embodiments, assuming that the light guide plate 2 includes N transflective interfaces 23. A reflectivity of each of the transflective interfaces 23 may be expressed by the following Equation II:

$${R}_{i} = \frac{1}{N} \times \frac{1}{{\prod }_{j = 1}^{i - 1} 1 - {R}_{j}} \qquad ( Equation II )$$

where R is the reflectivity, and i is a rank of one of the transflective interfaces 23, with the ranks of the transflective interfaces ordered in ascending order of distances to the light incident surface 21 of the light guide plate 2. For example, as shown in FIG. 3A, the light guide plate 2 of this embodiment includes five transflective interfaces 23. An order of the rightmost transflective interface 23 is 1 (that is, i=1), an order of the second right transflective interface 23 is 2 (that is, i=2), and an order of the leftmost transflective interface 23 is 5 (that is, i=5). Therefore, the reflectivity of each of the transflective interfaces 23 may be expressed in sequence as:

$${R}_{1} = 0.2$$

$${R}_{2} = \frac{1}{5} \times \frac{1}{( 1 - {R}_{1} )} = 0.25$$

$${R}_{3} = \frac{1}{5} \times \frac{1}{( 1 - {R}_{1} ) ( 1 - {R}_{2} )} = 0.33$$

$${R}_{4} = \frac{1}{5} \times \frac{1}{( 1 - {R}_{1} ) ( 1 - {R}_{2} ) ( 1 - {R}_{3} )} = 0.5$$

$${R}_{5} = \frac{1}{5} \times \frac{1}{( 1 - {R}_{1} ) ( 1 - {R}_{2} ) ( 1 - {R}_{3} ) ( 1 - {R}_{4} )} = 1$$

In this way, when light passes through each transflective interface 23, intensity of reflected light is the same, so that the visibility of the image for the observer at different observation angles is the same. In some embodiments, when the transflective interface 23 is the coated surface 25 between the light guide media 24, a refractive index of each coating material gradually increases with the order. Alternatively, a quantity of interference coating layers on each coated surface 25 gradually increases in order.

In some embodiments, a spacing d between the plurality of transflective interfaces 23 along the optical axis X1 is equal. In particular, as shown in FIG. 3A, a spacing d is defined between the five transflective interfaces 23 of the light guide plate 2, so that the spacing between reflected light generated when the parallel light beam Lp passes through these transflective interfaces 23 is also the same, thereby generating an image that is evenly distributed in space, and a problem that the image suddenly disappears or becomes blurred does not occur when the observer adjusts the observation angle.

FIG. 3B is a schematic diagram of a light guide plate according to some other embodiments of this application. Refer to FIG. 3B. In this embodiment, a light guide plate 2 includes a cavity 26 and a reflective surface 27, and a light emergence surface 22 of the light guide plate 2 is a transflective surface 28. The cavity 26 is located between the transflective surface 28 and the reflective surface 27, and the cavity 26 includes a plurality of transflective lenses 231 therein. The cavity 26 may be vacuum or filled with another medium such as air. A material of the reflective surface 27 may be, but is not limited to, aluminum, silver, gold, silicon dioxide (SiO₂), titanium dioxide (TiO₂), magnesium fluoride (MgF₂), aluminum oxide, silicon nitride, polycarbonate, or polytetrafluoroethylene (PTFE). Similar to the embodiment of FIG. 3A, a light incident surface 21 of the light guide plate 2 of this embodiment is arranged on a plate side of the light guide plate 2, and the light incident surface 21 forms a first oblique angle θ1 with the transflective surface 28. In this way, when a parallel light beam Lp passes through the light incident surface 21 orthogonally, an incident angle and a reflection angle of the parallel light beam Lp on the transflective surface 28 are also the first oblique angle θ1. The transflective lenses 231 are arranged in sequence along an optical axis X1 parallel to the transflective surface 28, and each of the transflective lenses 231 forms a second oblique angle θ2 with the transflective surface 28. In some embodiments, a spacing d between the plurality of transflective lenses 231 along the optical axis X1 is equal.

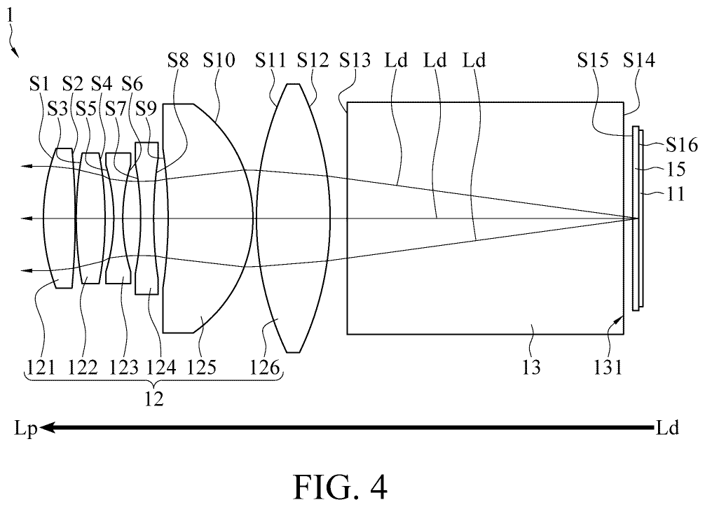

FIG. 4 is a schematic diagram of an imaging module according to a first embodiment of this application. Refer to FIG. 4. In this embodiment, an imaging module 1 includes a display screen 11 and a lens assembly 12. The display screen 11 is arranged at one side of the lens assembly 12, and the light guide plate 2 is arranged at an other side of the lens assembly 12. Herein, the display screen 11 is configured to generate a divergent light beam Ld. The display screen 11 may be, but is not limited to, a Thin-Film Transistor Liquid Crystal Display (TFT LCD), an organic light-emitting diode (OLED), a micro light-emitting diode (MicroLED), or a light-emitting diode (LED). The display screen 11 serves as a planar light source under an ideal condition. However, in fact, the display screen 11 generates not only light in a direction orthogonal to the display screen 11, but also light in another direction, thereby forming the divergent light beam Ld. In addition, in some embodiments, a size of the display screen 11 does not match a size of the light incident surface 21 of the light guide plate 2. Therefore, a size of an image generated by the display screen 11 needs to be adjusted.

The lens assembly 12 is configured to convert the divergent light beam Ld into a parallel light beam Lp, so that an imaging focal length of a virtual image presented by the projection device 10 to the observer is located at infinity, so as to reduce visual disparity between a distance of the virtual image and an external environment object. On the other hand, the lens assembly 12 may also be configured to reduce the size of the image generated by the display screen 11, to generate a high-resolution image that may be projected through the light guide plate 2. A lens material of the lens assembly 12 may be quartz or plastic. In this embodiment, as shown in FIG. 4, the lens assembly 12 includes a first biconvex lens 121, a second biconvex lens 122, a first biconcave lens 123, a second biconcave lens 124, a convex-concave lens 125, and a third biconvex lens 126 in sequence from left to right. In this embodiment, the parameters of the lens assembly 12 are presented in Table 1 (attached at the end of this article). The first biconvex lens 121 includes a light emergence surface S1 and a light incident surface S2. The second biconvex lens 122 includes a light emergence surface S3 and a light incident surface S4. The first biconcave lens 123 includes a light emergence surface S5 and a light incident surface S6. The second biconcave lens 124 includes a light emergence surface S7 and a light incident surface S8. The convex-concave lens 125 includes a light emergence surface S9 and a light incident surface S10. The third biconvex lens 126 includes a light emergence surface S11 and a light incident surface S12. In this embodiment, the convex-concave lens 125 and the third biconvex lens 126 converge the divergent light beam Ld generated by the display screen 11 to reduce a cross-sectional area of the light beam. The first biconcave lens 123 and the second biconcave lens 124 cooperate with the convex-concave lens and the third biconvex lens to eliminate image chromatic aberration. The first biconvex lens 121 and the second biconvex lens 122 gradually adjust the divergent light beam Ld to the parallel light beam Lp.

In some embodiments, the imaging module 1 includes the display screen 11, the lens assembly 12, and a prism 13. The prism 13 is arranged between the display screen 11 and the lens assembly 12. The display screen 11 is coupled to a light incident surface 131 of the prism 13. As shown in FIG. 4, the display screen 11 is coupled to the light incident surface 131 of the prism 13 through a protection plate 15. The prism 13 increases a distance between the display screen 11 and the lens assembly 12, so that the image generated by the display screen 11 is completely projected onto the light incident surface S12 of the third biconvex lens and converged, and light is prevented from causing reflection loss or serious dispersion due to an excessive refractive index difference when passing through the light incident surface S12. The protection plate 15 prevents friction between the display screen 11 and the prism 13 due to vibration. In some embodiments, the protection plate 15 and the display screen 11 and/or the protection plate 15 and the prism 13 may be bonded together through an optical adhesive. In this embodiment, the parameters of the lens assembly 12 are presented in Table 2 (attached at the end of this article).

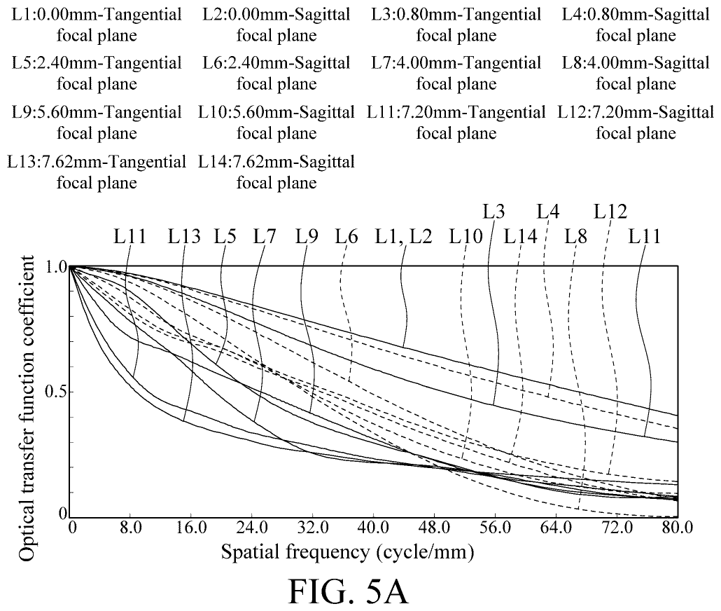

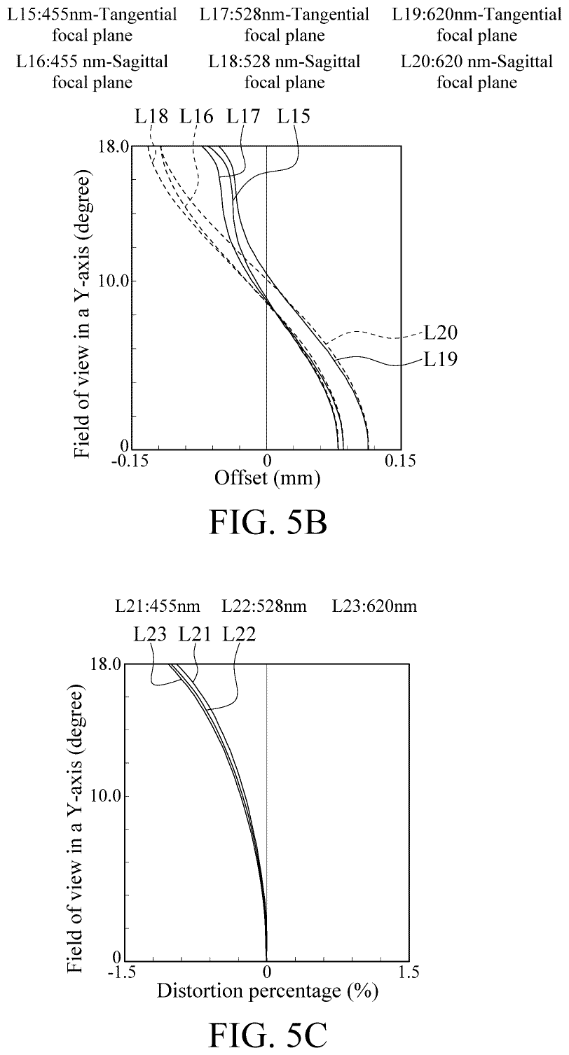

FIG. 5A is a diagram of a modulation transfer function (MTF) of an imaging module according to some embodiments of this application. Refer to FIG. 5A. In FIG. 5A, a horizontal axis represents a spatial frequency of a projected image of an imaging module 1, and a longitudinal axis represents an optical transfer function coefficient. In FIG. 5A, MTFs of light at different object heights (0.00 mm, 0.80 mm, 2.40 mm, 4.00 mm, 5.60 mm, 7.20 mm, and 7.62 mm) of an image displayed by a display screen 11 on a tangential focal plane are presented by L1, L3, L5, L7, L9, L11 and L13, and MTFs of light at different object heights (0.00 mm, 0.80 mm, 2.40 mm, 4.00 mm, 5.60 mm, 7.20 mm, and 7.62 mm) on a sagittal focal plane are presented by L2, L4, L6, L8, L10, L12 and L14. The MTFs present contrast retention ability of the imaging module 1 at different spatial frequencies, and values of the MTFs on each curve decrease with an increase in the spatial frequency. It can be seen from FIG. 5A that for an image on the tangential focal plane with an object height of more than 5.6 mm, the MTF of the imaging module 1 quickly drops below 0.7 within a spatial frequency of 8.0 cycles/millimeter, and the MTFs on other curves present a slow decrease with the increase in the spatial frequency.

FIG. 5B is a diagram of field curvature of an imaging module according to some embodiments of this application. FIG. 5C is a distortion diagram of an imaging module according to some embodiments of this application. Refer to FIG. 5B and FIG. 5C together. In FIG. 5B, a horizontal axis represents an offset between an imaging focus and a paraxial focal plane, and a longitudinal axis represents a field of view of the imaging focus in a Y-axis direction (an up-down direction in FIG. 2). In FIG. 5B, a focus offset of light of different wavelengths (455 nm, 528 nm, and 620 nm) on a tangential focal plane is presented by L15, L17 and L19, and a focus offset of light of different wavelengths (455 nm, 528 nm, and 620 nm) on a sagittal focal plane is presented by L16, L18 and L20. In FIG. 5C, a horizontal axis represents a distortion percentage, and a longitudinal axis represents a field of view of an imaging focus in a Y-axis direction. In this embodiment, the maximum field of view of the imaging focus is 18 degrees, tangential field curvature and sagittal field curvature are both less than 0.15 mm, and the maximum distortion is within-1.2%.

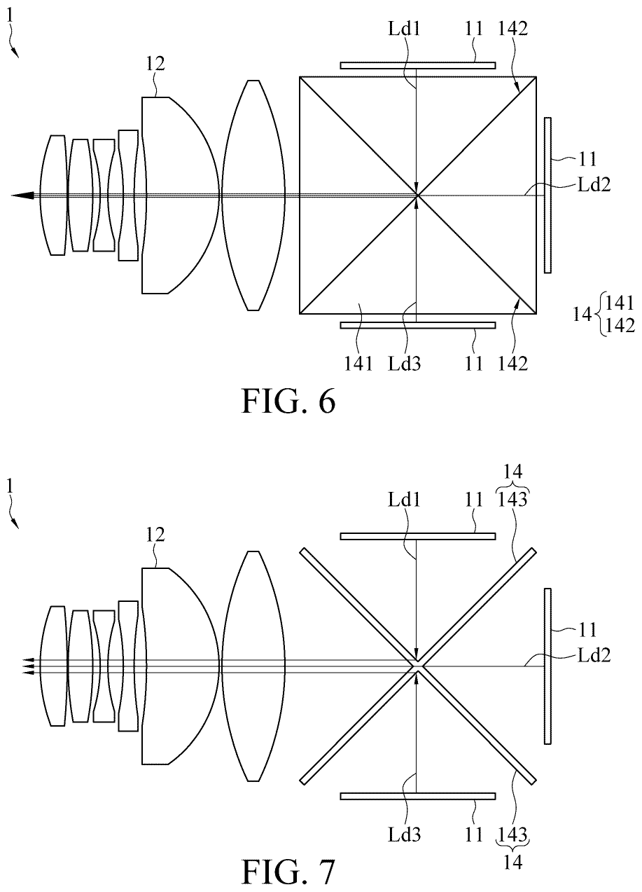

FIG. 6 is a schematic diagram of an imaging module according to a second embodiment of this application. Refer to FIG. 6. In some embodiments, an imaging module 1 includes a plurality of display screens 11, a light combining component 14, and a lens assembly 12. Each of the display screens 11 is configured to generate a divergent monochromatic light beam. The light combining component 14 is arranged between the plurality of display screens 11 and the lens assembly 12. Each of the display screens 11 is coupled to a different light incident surface of the light combining component 14. In this embodiment, the imaging module 1 includes three display screens 11, which are respectively a red light display screen 11 (configured to generate a red divergent light beam Ld1), a green light display screen 11 (configured to generate a green divergent light beam Ld2), and a blue light display screen 11 (configured to generate a blue divergent light beam Ld3). The light combining component 14 of this embodiment is a light combining prism 141. The light combining prism 141 may be composed of a plurality of sub-prisms, and a coated surface 142 is provided between the sub-prisms. The coated surface 142 has a filtering effect, allows light of a specific wavelength to transmit, and reflects light of other wavelengths. For example, the coated surface 142 of the light combining prism 141 in FIG. 6 allows the green divergent light beam Ld2 to directly transmit, and reflects the red divergent light beam Ld1 and the blue divergent light beam Ld3. The light combining prism 141 mixes all monochromatic divergent light beams Ld to generate a mixed color divergent light beam Ld, and then the lens assembly 12 converts the mixed-color divergent light beam Ld into a parallel light beam Lp. In this embodiment, the imaging module 1 displays light of different colors through the plurality of display screens 11, so that the light of each color can be presented more delicately. In some embodiments, a refractive index of the light combining prism 141 may match that of a lens of the lens assembly 12 or a protection plate 15 of the display screen 11. In some embodiments, the display screen 11 and the light combining prism 141 and/or the protection plate 15 and the light combining prism 141 may be bonded together through an optical adhesive.

FIG. 7 is a schematic diagram of an imaging module according to a third embodiment of this application. Refer to FIG. 7. In this embodiment, an imaging module 1 includes three display screens 11, and a light combining component 14 is composed of a plurality of optical filters 143. Similar to the coated surface 142 of the light combining prism 141 in the second embodiment, each of the optical filters 143 of this embodiment has a filtering effect, allows light of a specific wavelength to transmit, and reflects light of other wavelengths. Compared with the light combining prism 141, the light combining component 14 using the optical filter 143 allows lower component and manufacturing costs.

The features such as the proportional relationship, structure, and size shown in the figures of this application are only used to illustrate the embodiments described in this application, so as to facilitate reading and understanding of this application by a person of ordinary skill in the art to which this application belongs, and are not intended to limit the scope of rights of this application. In addition, any change, modification, or adjustment to the content described in the foregoing embodiments shall fall within the scope of rights claimed in this application without affecting the objective and effect of this application.

TABLE 1
Parameter list of the lens assembly 12 according
to some embodiments of this application

| | | Radius of | | | | Focal |
|---|---|---|---|---|---|---|
| | | curvature | Thickness | Refractive | Abbe | length |
| Component | Surface | (mm) | (mm) | index | number | (mm) |
| 121 | S1 | 16.99 | 2.74 | 1.81 | 25.43 | 17.00 |
| | S2 | −70.26 | 0.15 | | | |
| 122 | S3 | 34.02 | 2.45 | 1.62 | 60.29 | 27.63 |
| | S4 | −34.02 | 0.76 | | | |
| 123 | S5 | −15.39 | 0.77 | 1.81 | 25.43 | −9.32 |
| | S6 | 15.39 | 1.58 | | | |
| 124 | S7 | −23.24 | 1.11 | 1.81 | 25.43 | −17.47 |
| | S8 | 37.72 | 1.27 | | | |
| 125 | S9 | −38.00 | 7.40 | 1.62 | 60.29 | 24.23 |
| | S10 | −11.63 | 0.18 | | | |
| 126 | S11 | 26.19 | 6.49 | 1.49 | 70.24 | 27.86 |
| | S12 | −26.19 | 1.50 | | | |

TABLE 2
Parameter list of the protection plate 15 and the prism
13 according to some embodiments of this application

| | | Radius of | | | | Focal |
|---|---|---|---|---|---|---|
| | | curvature | Thickness | Refractive | Abbe | length |
| Component | Surface | (mm) | (mm) | index | number | (mm) |
| 13 | S13 | Infinity | 24.00 | 1.52 | 1.52 | NA |
| | S14 | Infinity | 0.90 | | | |
| 15 | S15 | Infinity | 0.30 | 1.52 | 1.52 | NA |
| | S16 | Infinity | 0.10 | | | |

What is claimed is:

1. A projection device, comprising:
an imaging module, generating a parallel light beam; and
a light guide plate, comprising a light incident surface, a light emergence surface, and a plurality of transflective interfaces, wherein the light incident surface is coupled to the imaging module, the light incident surface forms a first oblique angle with the light emergence surface, the plurality of transflective interfaces are provided inside the light guide plate, and the plurality of transflective interfaces form a second oblique angle with the light emergence surface, and are arranged in sequence along an optical axis parallel to the light emergence surface.

2. The projection device according to claim 1, comprising a transflective plate, wherein the transflective plate is arranged above the light emergence surface of the light guide plate, and the transflective plate forms a third oblique angle with the light emergence surface.

3. The projection device according to claim 1, wherein the first oblique angle is less than 90 degrees and greater than a critical angle of total reflection of the parallel light beam on the light guide plate.

4. The projection device according to claim 1, wherein the light guide plate is composed of a plurality of light guide media, and each of the plurality of transflective interfaces is a coated surface between the light guide media.

5. The projection device according to claim 1, wherein the light guide plate comprises a cavity and a reflective surface, the light emergence surface of the light guide plate is a transflective surface, the cavity is located between the transflective surface and the reflective surface, and the plurality of transflective interfaces are a plurality of transflective lenses in the cavity.

6. The projection device according to claim 1, wherein a spacing between the plurality of transflective interfaces along the optical axis is equal.

7. The projection device according to claim 1, wherein the plurality of transflective interfaces comprise N transflective interfaces, and a reflectivity of each of the transflective interfaces is expressed as:
$${R}_{i} = \frac{1}{N} \times \frac{1}{{\prod }_{j = 1}^{i - 1} 1 - {R}_{j}}$$
wherein R is the reflectivity, and i is a rank of one of the transflective interfaces, with the ranks of the transflective interfaces ordered in ascending order of distances to the light incident surface.

8. The projection device according to claim 1, wherein the imaging module comprises a display screen and a lens assembly, the display screen generates a divergent light beam, the lens assembly converts the divergent light beam into the parallel light beam, and the lens assembly comprises a first biconvex lens, a second biconvex lens, a first biconcave lens, a second biconcave lens, a convex-concave lens, and a third biconvex lens in sequence.

9. The projection device according to claim 8, wherein the imaging module comprises a prism, the prism is arranged between the display screen and the lens assembly, and the display screen is coupled to a light incident surface of the prism.

10. The projection device according to claim 1, wherein the imaging module comprises a plurality of display screens, a light combining component, and a lens assembly, each of the display screens generates a divergent monochromatic light beam, the light combining component is arranged between the plurality of display screens and the lens assembly, each of the display screens is coupled to a different light incident surface of the light combining component, the light combining component mixes a plurality of divergent monochromatic light beams to generate a divergent combined light beam, and the lens assembly converts the divergent combined light beam into the parallel light beam.
